(19) United States
(12) Patent Application Publication
(10) Pub. No.: US 2006/0286260 A1
(43) Pub. Date: Dec. 21, 2006

(54) Quick dissolving agglomerated soluble fiber compositions and the process for making the same

(76) Inventors: Vin Nayak, Morganville, NJ (US); Smita Nayak, Morganville, NJ (US); Sultan Reshamwala, Leonia, NJ (US)

Correspondence Address: SMITA NAYAK, 17-A Cotters Lane, East Brunswick, NJ, 08816, US

(21) Appl. No.: 11/150,809

(22) Filed: Jun. 13, 2005

(51) Int. Cl. A23F 5/00

(52) U.S. Cl. 426/594

(57) ABSTRACT

A rapidly dispersible, non-gelling, non-gritty low-viscosity producing powder having use as a laxative and fiber supplement essentially containing non-digestible maltodextrin agglomerated with natural gums is disclosed. Non-digestible maltodextrins containing 30-40% hydro-alcohol precipitable fiber content are agglomerated in a fluid bed agglomerator, utilizing a solution of gums like guar and acacia having greater than 70% hydro-alcohol precipitable fiber content. These fiber agglomerates when added to water or liquid beverages disperse within few seconds without needing any mechanical stirring. Fiber powder agglomerates produced utilizing the current invention dispersed within seconds without forming any lumps in soft foods like yogurt, soft ice cream, pudding, thick soups, sauce, and fruit puree. Agglomerated powders enriched a variety of soft foods and beverages with high doses of fiber, without significantly altering the taste or texture.

### BACKGROUND OF THE INVENTION

1. Field of the Invention

The present invention relates to compositions and method of preparation of rapidly dissolving soluble fiber agglomerations containing non-digestible maltodextrins and natural gums like guar.

2. Description of the Related Art

Non-digestible maltodextrin (Fibersol 2, commercially available from Matsutani Chemical Industry Co.) is a soluble dietary fiber produced from cornstarch by pyrolysis and subsequent enzymatic treatment to convert a portion of the normal alpha-1,4 glucose linkages to random 1,2-, 1,3-, and 1,4-alpha or beta linkages thus resulting in molecules not absorbable in the small intestine and resistant to digestion. The human digestive system effectively digests only alpha 1,4-linkages. Non-digestible maltodextrin is partially fermented in the large intestine and the portions that are not utilized are excreted unchanged. Non-digestible maltodextrins retain their dietary fiber characteristics and functions across all processes that are normally utilized in the ready-to-eat food processing and packaging. Stability to acid and heat/retort processing—including stability in high acid, hot filled, aseptic, or pasteurized products like juices, sauces, puddings, fluid milks, and sports drinks makes this type of maltodextrin suitable for the manufacture of a variety of food and nutritional supplements.

Studies indicate that non-digestible maltodextrin type of soluble fibers can effectively reduce serum blood glucose and insulin levels potentially allowing formulation in foods for diabetics, weight control, and managing serum glucose before, during, and after exercise. These soluble fibers significantly reduce levels of blood triglycerides and serum cholesterol. Additionally, they effectively retain levels of HDL cholesterol. By adding stool volume and moisture, and reducing transit time, soluble fibers help maintain good colon health, potentially reducing the incidence of various types of colon diseases and cancers. In addition, non-digestible maltodextrin has been shown to prevent atrophy of the lining of the large intestine and does not create excess gas associated with some soluble dietary fibers. Water-soluble fiber can effectively promote the growth of a variety of beneficial bacteria in the colon. By promoting the growth of beneficial bacteria, soluble fibers indirectly reduce the presence of undesirable bacterial species. A variety of fermentation by-products such as short chain fatty acids and trace nutritional molecules can help in maintaining good intestinal and overall health. Additional benefits of increasing fiber consumption include reduced risk of some types of cancer (including breast cancer) and coronary heart disease, regulation of blood glucose and insulin, lowering of the concentration of blood lipids, reduced risk of cardiovascular disease and controlling diabetes, alleviating constipation, hemorrhoids and diverticulitis (Wolk, A., et al., JAMA, 281(21): 1998-2004 (1999); Kritchevsky, D., Cereal Foods World, 42(2): 81-85 (1977).

Non-digestible maltodextrins contain relatively small molecular weight polymeric chains that are highly soluble in water. Due to their low molecular weight compared to the other natural soluble fibers, they are not easily precipitated by the 78% alcoholic solution resulting in only 30 to 40% fiber content when analyzed by the traditional hydro-alcohol precipitation method. A modified method is required to analyze the small molecular weight compounds to get the actual fiber content of this product. In addition, the non-digestible maltodextrins, due to their low molecular weight and high solubility, do not impart a smooth mouth feel as provided by partially hydrolyzed guar gums. Controlled partially hydrolyzed guar gum, acacia, tragacanth and similar natural gums are easily precipitated by the 78% alcohol solution and provide a moderately low viscosity solution with excellent mouth feel.

In order to increase high molecular weight components in the non-digestible maltodextrin fiber, a combination of non-digestible maltodextrin with a natural gum is highly desirable. Such a combination will not only improve upon the molecular characteristics of the complex polysaccharide but also improve upon the mouth feel in certain beverages.

Several attempts have been made in the past to improve the dispersibility of psyllium husk powder in liquids. These include controlling particle size of the psyllium powder during the size reduction of the psyllium husk and coating the particles of psyllium powder with a surface coating. U.S. Pat. No. 4,996,051, describes a product that includes apple fiber, fructose, gum arabic, flavors and psyllium husk powder having a particle size that passes through a No. 50 mesh screen. Surface coating described by Colliopoulos et al. in U.S. Pat. No. 4,459,280 includes a dispersing agent, maltodextrin. A second surface coating described by Powell et al. U.S. Pat. No. 4,321,263 includes one of the dispersing agents, propylene glycol or polyvinyl pyrrolidone or blends. U.S. Pat. No. 6,312,730 describes a readily dispersible psyllium powder coated with gum acacia.

U.S. Pat. No. 6,610,347 discloses a dietary fiber composition produced by a process involving cooking a calcium caseinate or calcium caseinate and whey protein isolate slurry in an evaporator to produce a slurry of cross-linked matrices of protein, adding dietary fiber to the slurry of cross-linked matrices of protein to form a mixture, and spray atomizing the mixture in a spray dryer to produce the dietary fiber composition. U.S. Pat. No. 6,716,466 describes a balanced powder blend composition with at least one fat or oil source, at least one carbohydrate source, and at least one protein source. This composition is advantageously added to a food to supplement the nutritional value of the food, but without substantially altering the taste of the food.

### SUMMARY OF THE INVENTION

The present invention includes composition for rapidly dispersible, non-gelling, non-gritty, low-viscosity producing powders having use as laxative and fiber supplement, a method for making the powders and a method for preparing a treatment for constipation and fiber supplementation.

The powder includes non-digestible maltodextrin particles along with a low-viscosity natural gum agglomerated with a solution of natural gum or non-digestible maltodextrin. The powder, having use as a bulk laxative and fiber supplement, disperses rapidly in dispersing media such as water. Non-digestible maltodextrin due to their low molecular weight and high solubility do not impart a taste and sensory perception of other natural gums like partially hydrolyzed guar gums. Controlled partially hydrolyzed guar gum, acacia, tragacanth and similar natural gums are easily precipitated by the 78% alcohol solution and provide moderately low viscosity solutions with excellent mouth feel.

In order to improve upon the mouth feel and the organoleptic texture along with the high molecular weight components, a combination of non-digestible maltodextrin with a natural gum is highly desirable. Such a combination will not only improve upon the molecular characteristics of the complex polysaccharide but also improve upon the mouth feel in powder beverage compositions. Non-digestible maltodextrins are difficult to disperse in the powder form when added alone to any ingestible liquid or soft food. The fine particles of such powder do not wet very easily and form a floating residue on the top surface of the liquid which are hard to re-disperse.

The method for making the rapidly dispersible powder includes fluidizing the non-digestible maltodextrin particles and applying to the fluidized particles, an aqueous solution that includes natural gums and non-digestible maltodextrin. The solution is applied to the fluidized particles in a manner that promotes a uniform agglomeration of the powder. The solution is applied in a manner that produces a powder having a particle size distribution, moisture and bulk density that improve dispersibility of the composition in aqueous fluids. Most of the commercially marketed fiber products failed to disperse in cold water without brisk mixing resulting in gelatinous residues, which are unpleasant to taste or swallow. A time lag between the introduction of such commercial powders in the liquid and the starting of mixing results in lumps, which are often difficult to re-disperse.

A variety of treating agents like oil-soluble and water-soluble vitamins, minerals, herbal extracts, electrolytes, oral rehydrating salts, amino acids, antioxidants, antacids, antigas products, digestive enzymes, cholesterol lowering agents, anti-diarrheal agents, laxatives, gastric motility enhancing agents, ant-diabetic agents, dextrose to treat low blood sugar, soluble calcium and magnesium salts, and probiotics can be incorporated in the agglomerated fiber product.

### DETAILED DESCRIPTION OF THE PREFERRED EMBODIMENTS

The present invention includes composition for a rapidly dispersible agglomerated fiber powder having use as a laxative and a fiber supplement, that includes non-digestible maltodextrin and natural gum particles agglomerated with a solution of the natural gum or the non-digestible maltodextrin itself. The present invention also includes a method for making the powder and a method for preparing a constipation treatment and a fiber supplement using the powder.

The non-digestible maltodextrin particles preferably include a natural gum content of at least about 0.001% to 50% by weight. The powder also includes a moisture concentration within a range of about 0.1 to 8.0% by weight. The powder may optionally include flavorants, acidulants and sweeteners such as sucralose. The remaining powder weight is substantially the non-digestible maltodextrin. Fructo-oligosaccharides can also be partially substituted for the non-digestible maltodextrins. Fructo-oligosaccharides are a mixture of compounds composed of a chain of fructose molecules linked to a molecule of sucrose. Most preferably, they have a nystose to kestose to fructosyl-nystose ratio of about 40:50:10, by weight of the composition. Preferred fructo-oligosaccharides may be obtained by enzymatic action of fructosyltransferase on sucrose such as those commercially available from Beghin-Meiji Industries. Other fibers for use herein include arabinogalactans, inulin, xanthan gum, and pectins. Non-limiting examples of preferred, commercially available sources of arabinogalactan include Laracare family of products commercially available from Larex, Inc.

### EXAMPLES

The following examples will serve to further illustrate the components and details of preparation for the agglomerated non-digestible maltodextrin and guar gum combination of this invention. The invention, which is set forth in the foregoing disclosure, is not to be construed as being limited either in spirit or scope by these examples but rather by the claims set forth. Additionally, it should be recognized that those skilled in the art would readily realize that known variations and conditions and processes of the following preparations exist.

### Example No. 1

A bench model mini fluid bed agglomerator product bowl was charged with:

| | |
|---|---|
| Non-digestible Maltodextrin | 350.0 g |
| Low viscosity Guar gum | 100.0 g |

The bed was fluidized and mixed for a period of 5 minutes.

An agglomerating solution was prepared as follows:

| | | |
|---|---|---|
| Non-digestible Maltodextrin | 50.0 | g |
| Water | 110.0 | ml |

The maltodextrin water solution was heated to 50 degree C. and stirred until clear.

The bed was energized with inlet air temperature at 90 degree C. and the pump solution was delivered at a rate of 5.0 ml/minute. The product was then dried to a loss on drying moisture content of less than 5%.

The finished dust free product when dispersed in water formed an instant clear tasteless solution within 30 seconds with no surface particles in evidence. The finished product had an untapped bulk density of approximately 0.25 g/cc. Each dose of 4.0 grams (leveled tablespoon) of this agglomerated powder contained approximately 3.0 g of total dietary fiber.

### Example No. 2

A bench model mini fluid bed agglomerator product bowl was charged with:

| | | |
|---|---|---|
| Non-digestible Maltodextrin | 450.0 | g |
| Low viscosity Guar gum | 40.0 | g |

The bed was fluidized and mixed for a period of 5 minutes.

An agglomerating solution was prepared as follows:

| | | |
|---|---|---|
| Low viscosity Guar gum | 10.0 | g |
| Water | 110.0 | ml |

The Guar gum water solution was heated to 50 degree C. and stirred until clear.

The bed was energized with inlet air temperature at 90 degree C. and the pump solution was delivered at a rate of 5.0 ml/minute. The product was then dried to a loss on drying moisture content of less than 5%.

The finished dust free product when dispersed in water formed an instant clear tasteless solution within 30 seconds with no surface particles in evidence. The finished product had an untapped bulk density of approximately 0.20 to 0.25 g/cc. Each dose of 4.0 grams (leveled tablespoon) of this agglomerated powder contained approximately 3.0 g of total dietary fiber.

### Example No. 3

A bench model mini fluid bed agglomerator product bowl was charged with:

| | | |
|---|---|---|
| Non-digestible Maltodextrin | 250.0 | g |
| Low viscosity Guar gum | 50.0 | g |
| Gum acacia | 150.0 | g |

The bed was fluidized and mixed for a period of 5 minutes.

An agglomerating solution was prepared as follows:

| | | |
|---|---|---|
| Non-digestible Maltodextrin | 50.0 | g |
| Water | 110.0 | ml |

The non-digestible Maltodextrin water solution was heated to 50 degree C. and stirred until clear.

The bed was energized with inlet air temperature at 90 degree C. and the agglomerating solution was delivered at a rate of 5.0 ml/minute. The product was then dried to a loss on drying moisture content of less than 5%.

The finished dust free product when dispersed in water formed an instant clear tasteless solution within 30 seconds with no surface particles in evidence. The finished product had an untapped bulk density of approximately 0.20 to 0.3 g/cc. Each dose of 4.0 grams (leveled tablespoon) of this agglomerated powder contained approximately 3.0 g of total dietary fiber.

### Example No. 4

A bench model mini fluid bed agglomerator product bowl was charged with:

| | | |
|---|---|---|
| Non-digestible Maltodextrin | 250.0 | g |
| Low viscosity Guar gum | 50.0 | g |
| Gum acacia | 150.0 | g |
| FD&C Yellow #6 dye | 0.25 | g |
| Sucralose | 0.75 | g |
| Citric acid | 20.0 | g |
| Encapsulated Orange flavor | 0.3 | g |

The bed was fluidized and mixed for a period of 5.0 minutes.

An agglomerating solution was prepared as follows:

| | | |
|---|---|---|
| Non-digestible Maltodextrin | 50.0 | g |
| Water | 110.0 | ml |

The non-digestible Maltodextrin water solution was heated to 50 degree C. and stirred until clear. The bed was energized with inlet air temperature at 90 degree C. and the pump solution was delivered at a rate of 5.0 ml/minute. The product was then dried to a loss on drying moisture content of less than 5%.

The finished dust free product when dispersed in water formed an instant clear orange colored and flavored solution within 30 seconds with no surface particles in evidence. The finished product had an untapped bulk density of approximately 0.20 to 0.3 g/cc. Each dose of 4.0 grams (leveled tablespoon) of this agglomerated powder contained approximately 3.0 g of total dietary fiber.

### Example No 5

A bench model mini fluid bed agglomerator product bowl was charged with:

| | | |
|---|---|---|
| Non-digestible Maltodextrin | 425.0 | g |
| Hydrolyzed Guar gum | 50.0 | g |
| FD&C Yellow #6 dye | 0.25 | g |
| Sucralose | 0.75 | g |
| Citric acid | 20.0 | g |
| Encapsulated Orange flavor | 3.0 | g |

The bed was fluidized and mixed for a period of 10 minutes.

An agglomerating solution was prepared as follows:

| | | |
|---|---|---|
| Hydrolyzed Guar gum | 25.0 | g |
| Water | 110.0 | ml |

The hydrolyzed guar gum water solution was heated to 50 degree C. and stirred until clear.

The bed was energized with inlet air temperature at 90 degree C. and the pump solution was delivered at a rate of 5.0 ml/minute. The product was then dried to a loss on drying moisture content of less than 5%.

The finished dust free product when dispersed in water formed an instant clear orange colored and flavored solution within seconds with no surface particles in evidence. The finished product had an untapped bulk density of approximately 0.20 to 0.4 g/cc. Each dose of 4.0 grams (leveled tablespoon) of this agglomerated powder contained approximately 3.0 g of total dietary fiber.

### Example No 6

A bench model mini fluid bed agglomerator product bowl was charged with:

| | | |
|---|---|---|
| Non-digestible Maltodextrin | 300.0 | g |
| Gum acacia | 75.0 | g |
| FD&C Yellow #6 dye | 0.25 | g |
| Sucralose | 0.75 | g |
| Citric acid | 20.0 | g |
| Glucosamine hydrochloride | 150.0 | g |
| Encapsulated Orange flavor | 3.0 | g |

The bed was fluidized and mixed for a period of 5.0 minutes.

An agglomerating solution was prepared as follows:

| | | |
|---|---|---|
| Gum Acacia | 25.0 | g |
| Water | 110.0 | ml |

The gum acacia water solution was heated up 50 degree C. and stirred until clear.

The bed was energized with inlet air temperature at 90.0 degree C. and the agglomeration solution was delivered at a rate of 5.0 ml/minute. The product was then dried to a loss on drying moisture content of less than 5%.

The finished dust free product when dispersed in water formed an instant clear orange colored and flavored solution within 30 seconds with no surface particles in evidence. The finished product had an untapped bulk density of approximately 0.30 to 0.35 g/cc. Each dose of 5.2 grams (tablespoon) of this agglomerated powder contained approximately 4.0 g of total dietary fiber and 1.2 grams of glucosamine.

### Example No 7

A bench model mini fluid bed agglomerator product bowl was charged with:

| | | |
|---|---|---|
| Non-digestible Maltodextrin | 450.0 | g |
| Citric acid | 20.0 | g |
| Calcium gluconate and calcium lactate | 375.0 | g |
| Encapsulated Orange flavor | 3.0 | g |

The bed was fluidized and mixed for a period of 2.0 minutes.

An agglomerating solution was prepared as follows:

| | | |
|---|---|---|
| Gum Acacia | 50.0 | g |
| FD&C Yellow #6 dye | 0.25 | g |
| Sucralose | 0.90 | g |
| Water | 110.0 | ml |

The gum acacia, yellow # 6, and sucralose water solution was heated to 50 degree C. and stirred until clear.

The bed was energized with inlet air temperature at 100 degree C. and the pump solution was delivered at a rate of 5.0 ml/minute. The product was then dried to a loss on drying moisture content of less than 5%.

The finished dust free product when dispersed in water formed an instant clear orange colored and flavored solution within 30 seconds with no surface particles in evidence. The finished product had an untapped bulk density of approximately 0.30 to 0.4 g/cc. Each dose of 7.0 grams (one and half table spoon) of this agglomerated powder contained approximately 3.0 g of total dietary fiber and 300 mg of elemental calcium.

### Example No 8

A bench model mini fluid bed agglomerator product bowl was charged with:

| | | |
|---|---|---|
| Non-digestible Maltodextrin | 450.0 | g |
| Citric acid | 20.0 | g |
| Calcium gluconate and calcium lactate | 375.0 | g |
| Encapsulated Orange flavor | 3.0 | g |

The bed was fluidized and mixed for a period of 2.0 minutes.

An agglomerating solution was prepared as follows:

| | | |
|---|---|---|
| Gum Acacia | 50.0 | g |
| FD&C Yellow #6 dye | 0.25 | g |
| Sucralose | 0.75 | g |
| Water | 110.0 | ml |

The gum acacia, yellow # 6, and sucralose water solution was heated to 50 degree C. and stirred until clear.

The bed was energized with inlet air temperature at 100 degree C. and the pump solution was delivered at a rate of 5.0 ml/minute. The product was then dried to a loss on drying moisture content of less than 5%.

The finished dust free product when dispersed in water formed an instant clear orange colored and flavored solution within 30 seconds with no surface particles in evidence. The finished product had an untapped bulk density of approximately 0.30 to 0.4 g/cc. Each dose of 7.0 grams (one and half table spoon) of this agglomerated powder contained approximately 3.0 g of total dietary fiber and 300 mg of elemental calcium. Most of the commercially marketed fiber products failed to disperse in cold water without brisk mixing. They form gelatinous residues instead. Starting time of mixing was critical for all the marketed products. Quick mixing action after the introduction of the powder in any liquid resulted in faster and cleaner dispersions. A time lag between the introduction of the powder in the liquid and the starting of mixing resulted in lumps, which are difficult to re-disperse. Agglomerated products formulated with the current invention formed lump free dispersions without any need for immediate mixing.

### Example No 9

A bench model mini fluid bed agglomerator product bowl was charged with:

| | | |
|---|---|---|
| Non-digestible Maltodextrin | 450.0 | g |
| Citric acid | 20.0 | g |
| Calcium gluconate and calcium lactate | 375.0 | g |
| Encapsulated Orange flavor | 3.0 | g |
| Low viscosity Guar gum | 50.0 | g |
| FD&C Yellow #6 dye | 0.25 | g |
| Sucralose | 0.75 | g |

The bed was energized with inlet air temperature at 90 degree C. and high-pressure steam was injected at a rate of 5.0 gms/minute for 25 minutes. The product was then dried to a loss on drying moisture content of less than 6%.

The finished dust free product when dispersed in water formed an instant clear orange colored and flavored solution within 30 seconds with no surface particles in evidence. The finished product had an untapped bulk density of approximately 0.30 to 0.4 g/cc. Each dose of 7.0 grams (one and half table spoon) of this agglomerated powder contained approximately 3.0 g of total dietary fiber and 300 mg of elemental calcium.

### Example No 10

A bench model mini fluid bed agglomerator product bowl was charged with:

| | | |
|---|---|---|
| Non-digestible Maltodextrin | 350.0 | g |
| Low viscosity Guar gum | 50.0 | g |

The bed was fluidized and mixed for a period of 5 minutes.

An agglomerating solution was prepared as follows:

| | | |
|---|---|---|
| Low viscosity Guar gum | 50.0 | g |
| Water | 110.0 | ml |

The maltodextrin water solution was heated to 50 degree C. and stirred until clear.

The bed was energized with inlet air temperature at 90 degree C. and the pump solution was delivered at a rate of 5.0 ml/minute. The product was then dried to a loss on drying moisture content of less than 5%.

Powder ingredients added to the fluid bed at the end of the drying cycle.

| | | |
|---|---|---|
| Citric acid | 20.0 | g |
| Calcium gluconate and calcium lactate | 375.0 | g |
| Encapsulated Orange flavor | 3.0 | g |
| FD&C Yellow #6 dye | 0.25 | g |
| Sucralose | 0.75 | g |

To the dried agglomerated fiber blend additional powder ingredients were added in the fluid bed and the bed was reenergized for 5 minutes to get a uniform granular blend

The finished product when dispersed in water formed an instant clear tasteless solution within 30 seconds with no surface particles in evidence. The finished product had an untapped bulk density of approximately 0.25 g/cc. Each dose of 4.0 grams (leveled tablespoon) of this agglomerated powder contained approximately 3.0 g of total dietary fiber.

What is claimed is:

1. A process for producing a soluble fiber powder composition, which produces clear, non gritty, non-viscous solution instantaneously when added to any consumable liquid or soft food, comprising of:
a) mixing non-digestible maltodextrins containing greater than 30% fiber content with low-viscosity forming natural gums or their derivatives;
b) forming an agglomeration with water or solutions of compounds selected from a group consisting of maltodextrins, natural gums, sugars, glycols, polypeptides, synthetic water soluble polymers and cellulosic derivatives; and
c) drying the mixture to form a dry, free-flowing, water dispersible, agglomerated dietary fiber with bulk density between 0.2 grams/cc to 0.7 grams/cc.

2. The process of claim 1 wherein the said non-digestible maltodextrin is present from 20 to 100% by weight on dry bases and the low viscosity gums or their derivatives in 0 to 70% by weight.

3. The process of claim 1 wherein the 78% alcohol-precipitable polymeric fiber content of the non digestible maltodextrin is increased from 30-40% to 40-80% by the incorporation of the low viscosity natural gums or their derivatives.

4. The process of claim 1 wherein the non-digestible maltodextrin is replaced in part by non-digestible fructo-oligosccharide, inulin, arabinogalactan, acacia and pectin.

5. The process of claim 1 wherein the low-viscosity gums or their derivatives are selected from a group comprising of guar, acacia, tragacanth, alginic acid, xanthan gum, modified cellulose, locust, pectin, and carrageenan

6. The process of claim 1 wherein a said composition contains additional added natural and artificial flavorants, acidulants and sweeteners.

7. The process of claim 1 wherein a treating agent is added to the composition to provide fiber compositions with added nutritional or therapeutic benefits.

8. Treating agent claimed in claim 7 is selected from a group comprising of oil and water soluble vitamins, minerals, herbal extracts, electrolytes, oral rehydrating salts, amino acids, antioxidants, antacids, antigas products, digestive enzymes, cholesterol lowering agents, anti-diarrheal agents, laxatives, gastric motility enhancing agents, ant-diabetic agents, dextrose to treat low blood sugar, soluble calcium and magnesium salts, and probiotics.

9. A consumable, fast dissolving clear, low-viscosity producing, bulk fiber composition consisting essentially of non-digestible maltodextrin agglomerated with natural soluble gum or its derivatives, said gum being present in an amount of at least 0.0001 percent by weight of the said composition and moisture being present within a range of about 0.1 to about 8.0 percent.

10. The composition of claim 9 additionally containing flavorants, acidulants and sweeteners.

11. The composition of claim 9 additionally containing a treating agent selected from a group comprising of oil-soluble and water-soluble vitamins, minerals, herbal extracts, electrolytes, oral rehydrating salts, amino acids, antioxidants, antacids, antigas products, digestive enzymes, cholesterol lowering agents, anti-diarrheal agents, laxatives, gastric motility enhancing agents, ant-diabetic agents, dextrose to treat low blood sugar, soluble calcium and magnesium salts, and probiotics.
